(19) United States
(12) Patent Application Publication
(10) Pub. No.: US 2010/0124456 A1
(43) Pub. Date: May 20, 2010

(54) APPARATUS FOR CLAMPING OR RELEASING A DRIVE WHEEL ON A SHAFT, SHEET-PROCESSING MACHINE AND SHEET-FED ROTARY PRINTING PRESS

(75) Inventors: Georg Grasmück, Deidesheim (DE); Markus Möhringer, Weinheim (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AKTIENGESELLSCHAFT, Heidelberg (DE)

(21) Appl. No.: 12/604,516

(22) Filed: Oct. 23, 2009

(30) Foreign Application Priority Data
Nov. 17, 2008 (DE) 10 2008 057 679.4

(51) Int. Cl. F16D 1/06

(52) U.S. Cl. 403/368

(57) ABSTRACT

An apparatus for clamping and releasing a drive wheel on a shaft, includes a spring device which encloses the shaft annularly to provide a direct clamping connection with the shaft. The spring device is connected to the drive wheel which can be a chain sprocket or a gearwheel. A sheet-processing machine and a sheet-fed rotary printing press, are also provided.

### CROSS-REFERENCE TO RELATED APPLICATION

This application claims the priority, under 35 U.S.C. §119, of German Patent Application DE 10 2008 057 679.4, filed Nov. 17, 2008; the prior application is herewith incorporated by reference in its entirety.

### BACKGROUND OF THE INVENTION

### Field of the Invention

The invention relates to an apparatus for clamping or releasing a drive wheel on a shaft. The invention also relates to a sheet-processing machine and a sheet-fed rotary printing press having the apparatus.

In order to ensure that a gearwheel or chain sprocket can be rotated with respect to its bearing point, for example in order to set a phase offset with respect to a second gearwheel or chain sprocket, the gearwheel or chain sprocket firstly has to be released.

Numerous apparatuses for that purpose are known from the prior art.

For example, German Patent DE 44 47 863 C2 discloses an apparatus for clamping or releasing a clamping connection of a gearwheel which is disposed on a bearing journal. An axially acting spring device, which is provided for clamping, achieves a radial clamping action through conically configured clamping elements, as a result of which the gearwheel is clamped on the bearing journal.

During clamping and releasing of the clamping connection, wear of the clamping elements occurs as a result of sliding on the conical face under load.

### SUMMARY OF THE INVENTION

It is accordingly an object of the invention to provide an apparatus for clamping or releasing a drive wheel on a shaft, a sheet-processing machine and a sheet-fed rotary printing press, which overcome the hereinafore-mentioned disadvantages of the heretofore-known devices of this general type and which provide for low wear.

With the foregoing and other objects in view there is provided, in accordance with the invention, an apparatus for clamping or releasing a drive wheel on a shaft. The apparatus comprises a spring device to be deflected axially. The spring device annularly encloses the shaft, the spring device has a clamping face acting directly on the shaft in radial direction, the spring device has an inner ring and an outer ring coaxially surrounding the inner ring, and spokes or struts couple the inner ring and the outer ring to one another.

It is a particular advantage of the radially acting clamping device that it can be clamped or released virtually without wear.

In accordance with another feature of the invention, the clamping device has a spring device in the form of a disk spring which is disposed on a shaft or a journal in such a way that it can be rotated but is fixed in terms of displacement.

In accordance with a further feature of the invention, the disk spring has an inner ring (bearing ring) which is connected to an outer ring through the use of radially disposed struts or spokes and the outer ring is disposed in such a way that it can be displaced in an axially resilient manner with respect to the inner ring, with the struts or spokes generating the spring force.

In accordance with a concomitant feature of the invention, the outer ring is preferably configured to be thicker than or at least as thick as the inner ring.

Other features which are considered as characteristic for the invention are set forth in the appended claims.

Although the invention is illustrated and described herein as embodied in an apparatus for clamping or releasing a drive wheel on a shaft, a sheet-processing machine and a sheet-fed rotary printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a sheet-fed rotary printing press;

FIG. 2 is a cross-sectional view of a drive wheel clamped on a shaft; and

FIG. 3 is a fragmentary, perspective view of a spring device with a radial clamping face.

### DETAILED DESCRIPTION OF THE INVENTION

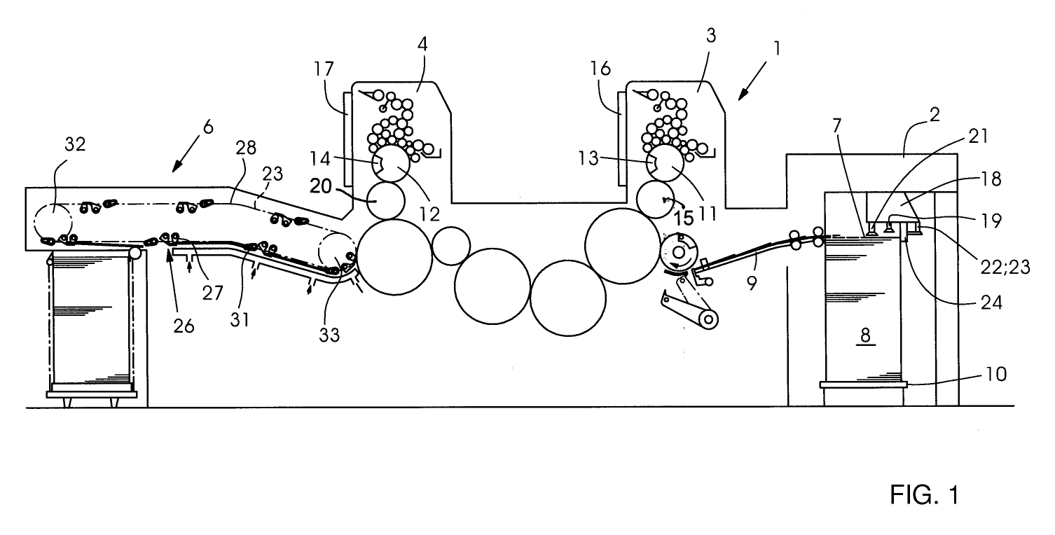

Referring now to the figures of the drawings in detail and first, particularly, to FIG. 1 thereof, there is seen a machine which processes sheets 7, for example a printing press 1, having a feeder 2, at least one printing unit 3, 4 and a delivery 6. The sheets 7 are removed from a sheet stack 8 and are fed individually or overlapped to the printing units 3, 4 over a feed table 9. In a known manner, the printing units 3 and 4 each include a respective plate cylinder 11, 12 and a respective blanket cylinder 15, 20 which interact in each case with the latter. The plate cylinders 11, 12 each have a respective clamping apparatus 13, 14 for fastening flexible printing plates. Moreover, each plate cylinder 11, 12 is associated with a respective apparatus 16, 17 for semiautomatic or fully automatic printing plate changing.

The sheet stack 8 lies on a stack board 10 which can be raised in a controlled manner. The sheets 7 are removed from the upper side of the sheet stack 8 through the use of a so-called suction head 18 which has, inter alia, a number of lifting and dragging suckers 19, 21 for separating the sheets 7. Moreover, blowing devices 22 are provided for loosening the upper sheet layers and sensing elements 23 are provided for stack tracking. A number of lateral and rear stops 24 are provided for aligning the sheet stack 8, in particular the upper sheets 7 of the sheet stack 8.

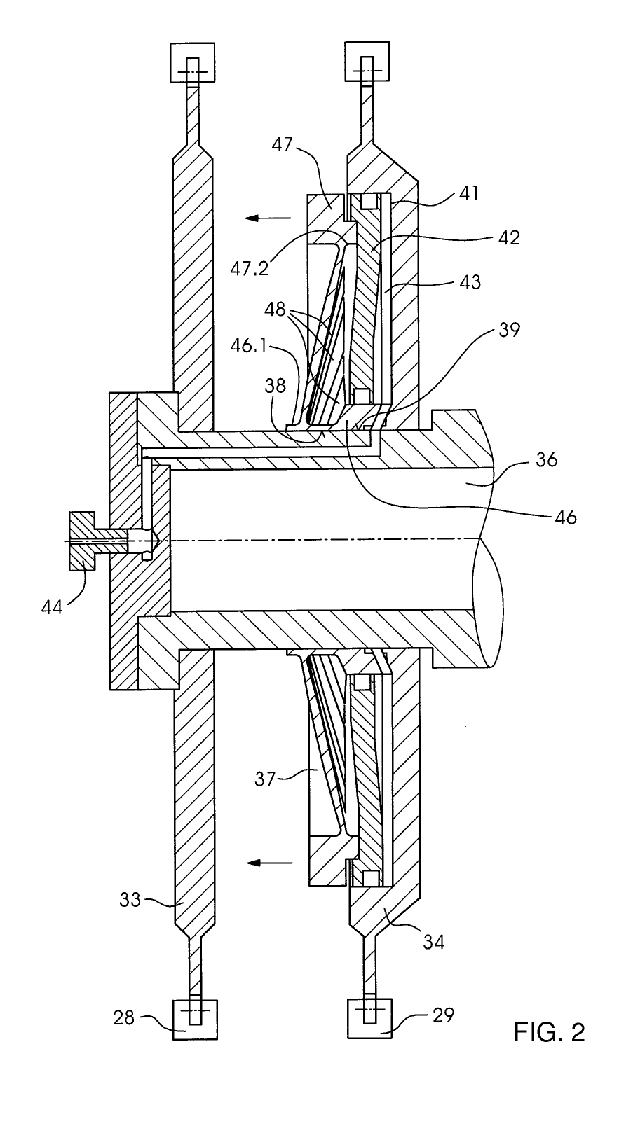

The delivery 6 has a chain gripper system 26, in which gripper bars 27 that are spaced apart from one another in the sheet transport direction are disposed on chains 28 which are guided in parallel in order to grip the sheet 7 at the front edge. A further chain pair 29, which is disposed parallel to the chains 28, has gripper bars 31 for gripping the rear sheet edge. The chains 28, 29 are deflected endlessly about drive wheels, for example chain sprockets 32, 33 and 34. The chain sprockets 33, 34 are seated on a common shaft 36 seen in FIG. 2. The chain sprocket 33 is seated fixedly on the shaft 36, while the chain sprocket 34 is disposed on the shaft 36 in such a way that it can be engaged.

In order to ensure that the gripper bars 31 for the rear sheet edge can be set to the format length of the sheet to be processed, the drive gearwheel or chain sprocket 34 can be rotated with respect to the shaft 36. To this end, the chain sprocket 34 is connected fixedly to an annular spring element 37. The spring element 37 encloses the shaft 36 coaxially and has a clamping face 38 which is in radial clamping connection with a clamping face 39 of the shaft 36.

The chain sprocket 34 has a cylindrical recess 41, in which a working piston 42 is guided axially. A working space 43 between the piston 42 and the cylinder 41 can be loaded through a rotary inlet 44 with a working medium, for example a pneumatic fluid, for moving the piston 42 into a position in which it provides a clamping connection between the sprocket 34 and the shaft 36 as seen in FIG. 2.

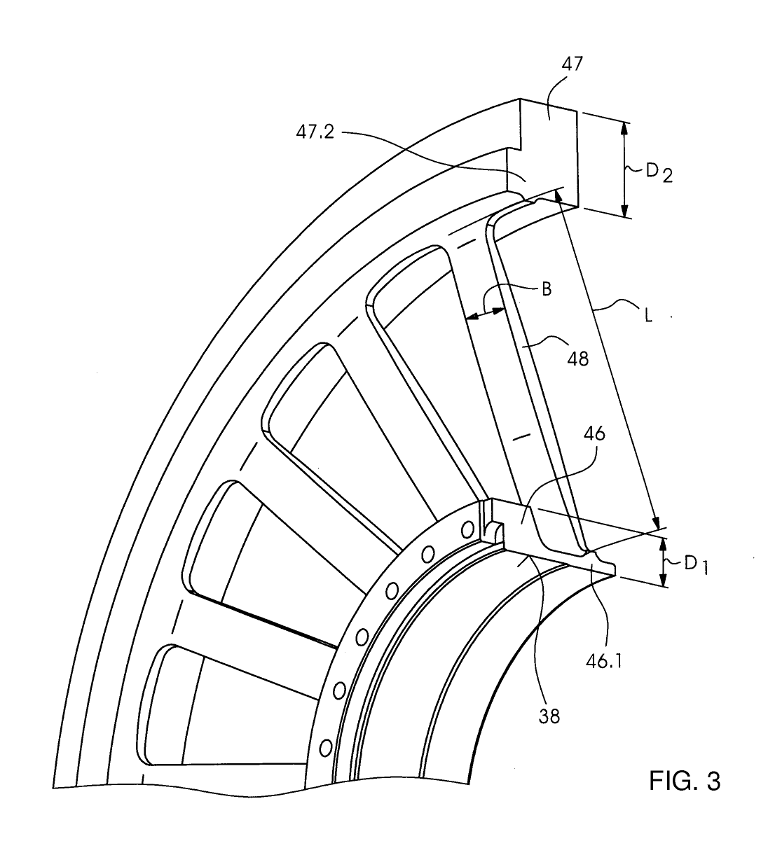

The spring element 37 has an inner ring 46 and an outer ring 47. The rings 46, 47 are disposed coaxially and are connected to one another through the use of a number of spokes or struts 48. As is seen in FIG. 3, the spokes or struts 48 have a large length relative to their diameter, that is to say a length L of the struts or spokes 48 is at least 5 times as large as a diameter or width B thereof (L=at least 5B).

The spokes or struts 48 are disposed at an axial end 46.1 of the inner ring 46 and extend in the radial direction obliquely to the outside, where they are disposed at an axial end 47.2 of the outer ring 47. The inner ring 46, the outer ring 47 and the spokes or struts 48 are configured in one piece. The inner ring 46 has a thickness D1 which is less than or equal to a thickness D2 of the outer ring 47 (D1≦D2).

In one preferred embodiment, the spring element 37 is inverted, as a result of which pressure loading of the working space leads to a release of the clamping connection.

The invention has been described by using a bearing seat of a chain sprocket 34 on a shaft 36. It goes without saying that the invention also includes the seating of a gearwheel on a shaft or a crown gear on a hub, etc.

1. An apparatus for clamping or releasing a drive wheel on a shaft, the apparatus comprising:
a spring device to be deflected axially;
said spring device annularly enclosing the shaft;
said spring device having a clamping face acting directly on the shaft in radial direction;
said spring device having an inner ring and an outer ring coaxially surrounding said inner ring; and
spokes or struts coupling said inner ring and said outer ring to one another.

2. The apparatus according to claim 1, wherein said spring device is fixedly connected to the drive wheel.

3. The apparatus according to claim 2, wherein said spokes or struts are disposed radially obliquely toward the outside.

4. The apparatus according to claim 2, wherein said inner ring has a thickness being less than or equal to a thickness of said outer ring.

5. The apparatus according to claim 1, wherein the drive wheel is a chain sprocket guiding a chain.

6. The apparatus according to claim 1, wherein the drive wheel is a gearwheel disposed on a shaft or hub.

7. A sheet-processing machine, comprising:
a chain delivery having an adjustable-phase drive wheel, a shaft, and a spring device according to claim 1.

8. A sheet-fed rotary printing press, comprising an apparatus according to claim 1.
